(19) United States
(12) Patent Application Publication
(10) Pub. No.: US 2009/0271733 A1
(43) Pub. Date: Oct. 29, 2009

(54) INFORMATION PROCESSING APPARATUS, CONTROL METHOD, AND STORAGE MEDIUM

(75) Inventor: Tatsuyoshi Noma, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/270,637

(22) Filed: Nov. 13, 2008

(30) Foreign Application Priority Data
Apr. 28, 2008 (JP) 2008-117781

(51) Int. Cl. G06F 3/048

(52) U.S. Cl. 715/784; 715/810

(57) ABSTRACT

According to one embodiment, an information processing apparatus includes a display unit which has a touch sensor on a screen, a detection unit which causes the touch sensor to detect that press on an arbitrary text of text data displayed on the display unit has continued for a predetermined time, a display control unit which displays a predetermined menu when the detection unit detects that the press has continued for the predetermined time, a selection unit which, when a selection start instruction to select part of the text data is selected from the displayed menu, and an instruction to scroll display of the text data is input, selects the text data to expand a selection range in a scroll direction, and a processing unit which, an execution instruction of a predetermined function is selected from the menu, processes the execution instruction for the selected text data.

### CROSS-REFERENCE TO RELATED APPLICATIONS

This application is based upon and claims the benefit of priority from Japanese Patent Application No. 2008-117781, filed Apr. 28, 2008, the entire contents of which are incorporated herein by reference.

### BACKGROUND

1. Field

One embodiment of the present invention relates to a technique of controlling an information processing apparatus having a touch sensor and, more particularly, to an information processing apparatus capable of easily using displayed text data, a control method, and a storage medium.

2. Description of the Related Art

In many PDAs with a touch sensor incorporated in a display, generally, the display has a small display area. The challenge for such a device is how to improve the visibility of a large quantity of information displayed on the display. For example, a technique disclosed in Jpn. Pat. Appln. KOKAI Publication No. 10-333866 is known, which reduces a whole display target image and displays it in another window. When a user selects an arbitrary point of the displayed reduced image, the selected part is sequentially enlarged and displayed.

However, the technique disclosed in Jpn. Pat. Appln. KOKAI Publication No. 10-333866 cannot easily execute processing of selecting or editing text data displayed on the display.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view showing the outer appearance of an information processing apparatus according to an embodiment of the present invention;

FIG. 2 is an exemplary block diagram showing the main components of the information processing apparatus according to the embodiment;

FIG. 3 is an exemplary block diagram showing the functional arrangement of a display control application;

FIG. 4 is an exemplary flowchart illustrating a display control method to which the information processing apparatus according to the embodiment is applied;

FIG. 5 is an exemplary conceptual view showing a state in which the display control application is displayed on the display of the information processing apparatus according to the embodiment;

FIG. 6 is an exemplary conceptual view showing a state in which the display control application is displayed on the display of the information processing apparatus according to the embodiment, and text data is scrolled;

FIG. 7 is an exemplary conceptual view showing a state in which the display control application is displayed on the display of the information processing apparatus according to the embodiment, and a start button is pressed;

FIG. 8 is an exemplary conceptual view showing a state in which the display control application is displayed on the display of the information processing apparatus according to the embodiment, and text data is selected;

FIG. 9 is an exemplary conceptual view showing a state in which the display control application is displayed on the display of the information processing apparatus according to the embodiment, and an item is pressed; and

FIG. 10 is an exemplary conceptual view showing a state in which the item “search” of the display control application is pressed on the display of the information processing apparatus according to the embodiment.

### DETAILED DESCRIPTION

Various embodiments according to the invention will be described hereinafter with reference to the accompanying drawings. In general, according to one embodiment of the invention, an information processing apparatus includes: a display unit which has a touch sensor on a screen; a detection unit which causes the touch sensor to detect that press on an arbitrary text of text data displayed on the display unit has continued for a predetermined time; a display control unit which displays a predetermined menu when the detection unit detects that the press has continued for the predetermined time; a selection unit which, when a selection start instruction to select part of the text data is selected from the displayed menu, and an instruction to scroll display of the text data is input, selects the text data to expand a selection range in a scroll direction; and a processing unit which, when the selection unit selects the text data, and an execution instruction of a predetermined function is selected from the menu, processes the execution instruction for the selected text data.

An embodiment of the present invention will now be described with reference to the accompanying drawing.

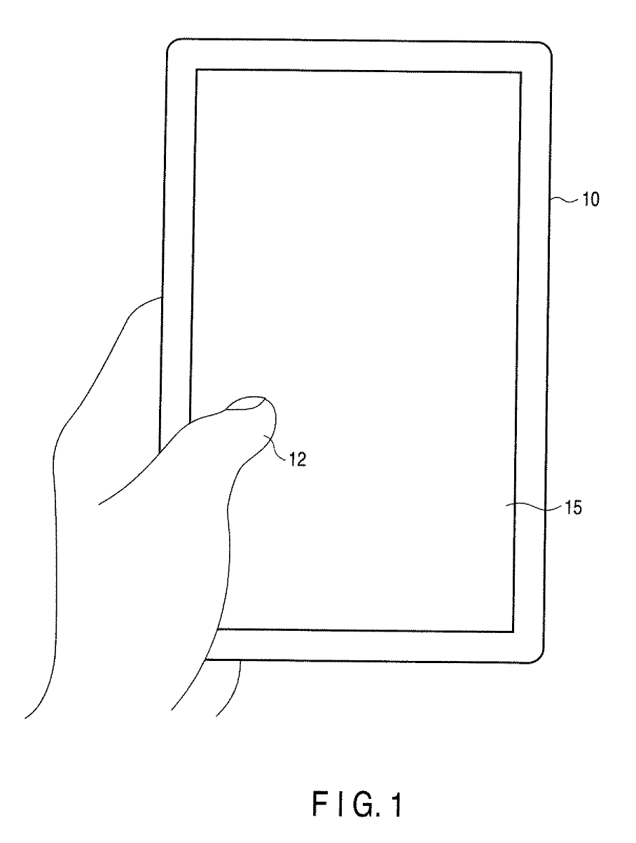

The arrangement of an information processing apparatus according to an embodiment of the present invention will be described with reference to FIG. 1.

FIG. 1 is a view showing the outer appearance of an information processing apparatus according to an embodiment, to which a control method of the present invention is applied. In this embodiment, the information processing apparatus is implemented as a PDA (Personal Digital Assistants) which includes a display (touch display) incorporating a touch sensor.

As shown in FIG. 1, a PDA 10 includes a display 15 incorporating a touch sensor. The display 15 allows to select displayed screen contents when a user touches it with a finger 12 or touch pen.

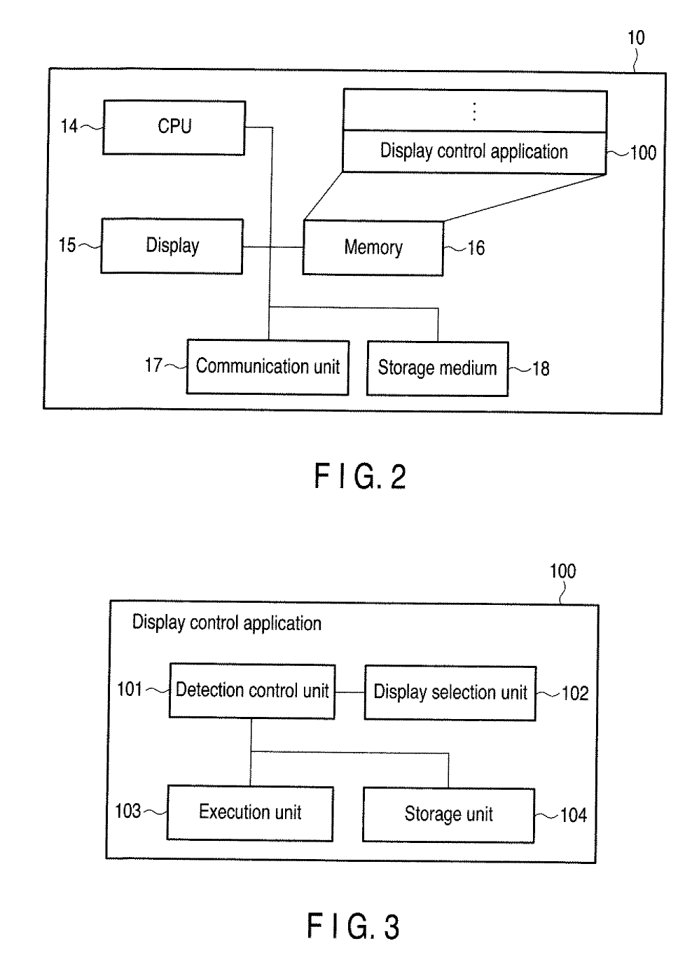

FIG. 2 is a block diagram showing the main components of the PDA that is the information processing apparatus of the embodiment.

As shown in FIG. 2, the PDA 10 includes a CPU 14, the display (display unit) 15, a memory 16, and a communication unit 17.

The CPU 14 is a control unit which comprehensively controls various devices of the PDA 10. The CPU 14 performs control by loading, to the memory 16, an OS (Operating System) and various applications such as a display control application 100 stored in a storage medium 18. The memory 16 is a storage medium such as a flash memory which temporarily stores data. The display 15 is a display device incorporating a touch sensor. It is possible to execute processing of, e.g., selecting a predetermined area on the display as an reaction to press of a user's finger or touch pen. The storage medium 18 has a larger capacity than the memory 16 such as an HDD or flash memory and stores the OS, various applications, and internal dictionaries. The communication unit 17 is a connection interface to be connected to the Internet or the like. The communication unit 17 is a 3G module for a wireless LAN function or a portable phone.

The functional arrangement of the display control application 100 will be described next with reference to the block diagram in FIG. 3.

The display control application 100 includes a detection control unit (detection unit) 101, display selection unit (display control unite selection unit) 102, execution unit (processing unit) 103, and storage unit 104. The detection control unit 101 detects press of the user's finger 12 or touch pen. When text data or the like is selected by the user's finger 12 or touch pen, the display selection unit 102 executes processing of, e.g., highlighting the selected text data or the like. The execution unit 103 executes predetermined processing such as copy, delete, paste, cut, or search of the selected text data. A search of the selected text data is done in the internal dictionary data or on the Internet via the communication unit 17. The storage unit 104 stores display menus to be displayed upon detecting press of the user's finger 12 or touch pen and item data (e.g., copy, delete, paste, cut, and search) of predetermined processing (execution instruction) (an execution instruction includes one of copy, paste, delete, search, and cut).

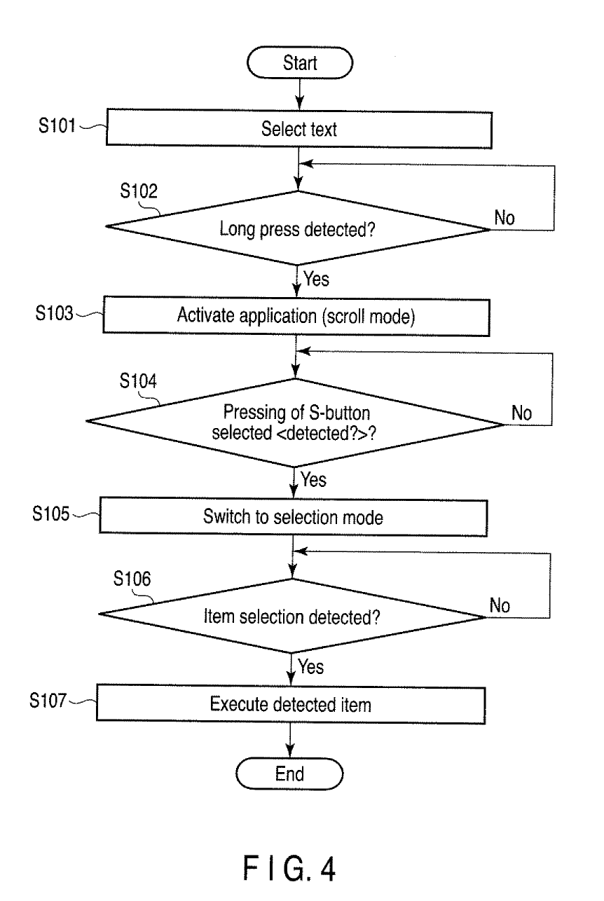

A display control method to which the information processing apparatus according to the embodiment is applied will be described next with reference to the flowchart in FIG. 4.

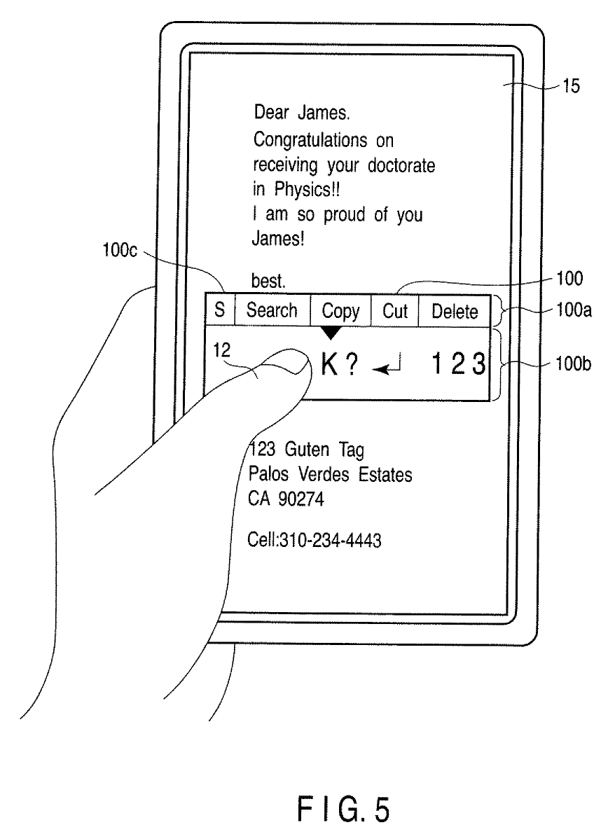

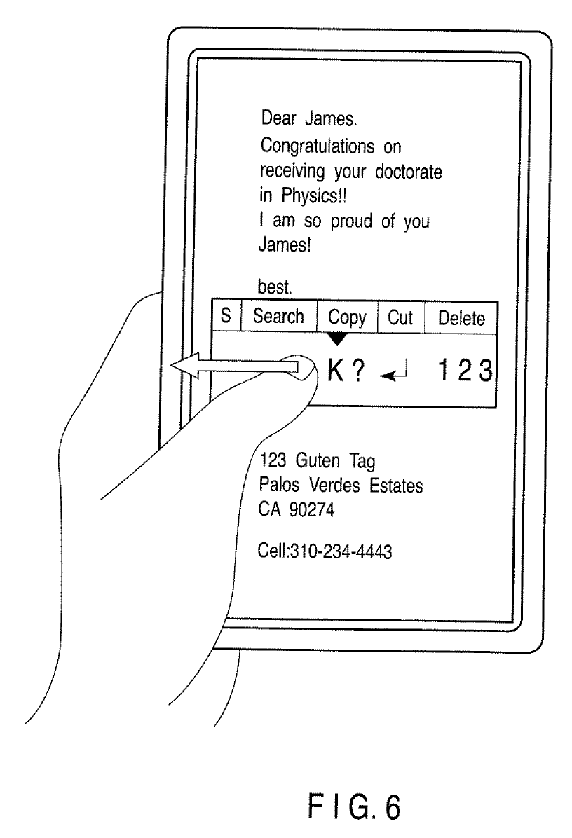

First, the user selects text data displayed on the display 15 by pressing it with, e.g., the finger 12 (block S101). Text data can be selected not only by press of the user's finger 12 but also by press of a touch pen. The CPU 14 determines whether the press on the display 15 is long press (the screen of the display remains pressed for a predetermined time) (block S102). Upon determining in block S102 that the press on the display 15 is long press (YES in block S102), the CPU 14 loads the display control application 100 from the storage medium 18 to the memory 16 and activates it (block S103). As shown in FIG. 5, the activated display control application 100 has, e.g., a menu display area 100a where predetermined processing (e.g., copy, delete, paste, cut, or search) is executed, a text data enlargement display area 100b (display area where a scrolled part of the text data is enlarged and displayed), and a start button (S button) 100c. In this case, the display control application 100 is in a scroll mode. In the scroll mode, it is possible to scroll display of the text data in, e.g., the scroll direction of the user's finger 12, as shown in FIG. 6 (before a selection start instruction is input, the text data is scrolled in the scroll direction). The display control application 100 can be turned off by pressing an area on the display where the display control application 100 is not displayed.

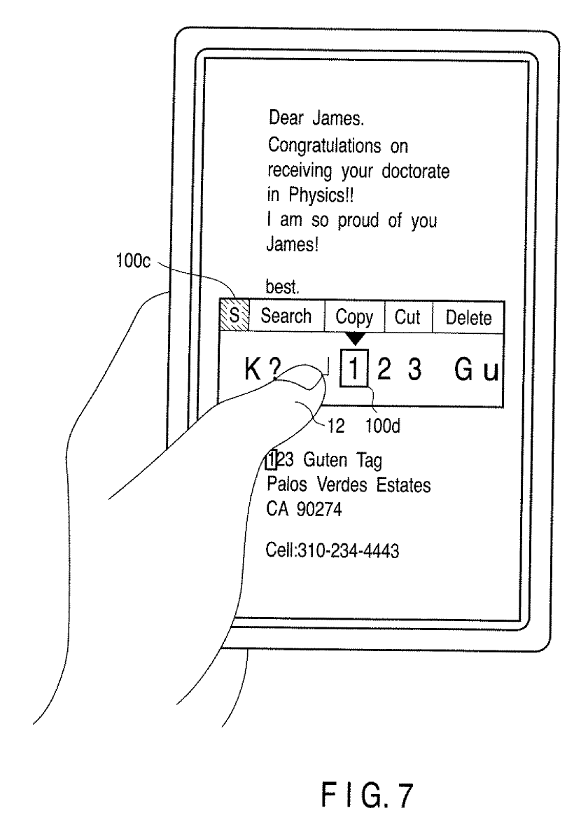

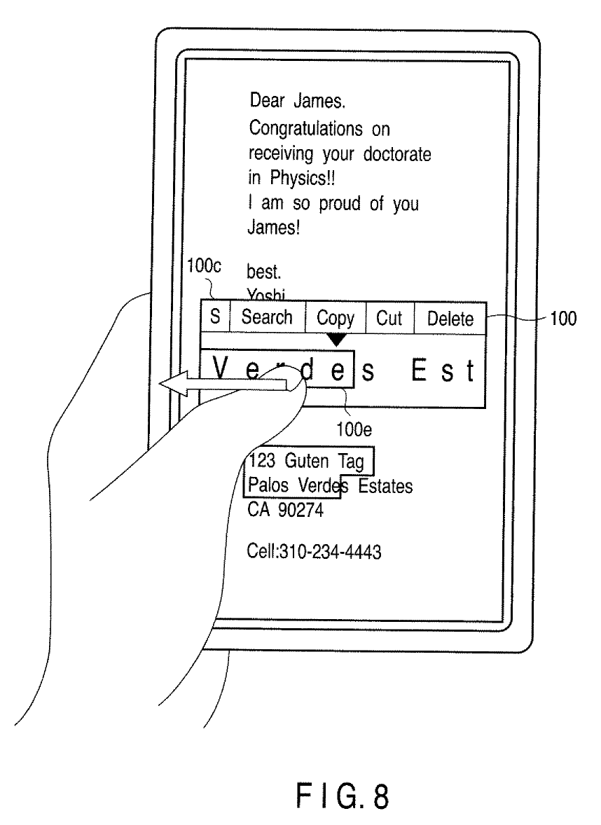

Upon detecting press on the S button (start button) (YES in block S104: see FIG. 7), the display control application 100 switches to a text data selection mode (block S105). In this mode, the text data is displayed in a box from the selection start point (see 100d in FIG. 7), as shown in FIG. 7. The displayed text data can be selected in, e.g., the scroll direction of the user's finger 12, as shown in FIG. 8. The selected area, which successively expands in the scroll direction while enclosing the text data in the box, is displayed in a highlighted state (see 100e in FIG. 5). If the scroll direction is reversed after the area has successively expanded in the scroll direction while enclosing the text data in the box, as described above, the area enclosing the text data in the box successively contracts in the scroll direction. More specifically, the area can scroll to the left or right side from the selection start point (starting point: see 100d in FIG. 7) where the text data is displayed in the box so that the area successively expands to the left or right side from the starting point (the area that encloses the text data becomes large). On the other hand, toward the starting point, the area enclosing the text data successively contracts in the scroll direction. On the starting point, only the text data (e.g., 100d: see FIG. 7) at the starting point is closed in the box.

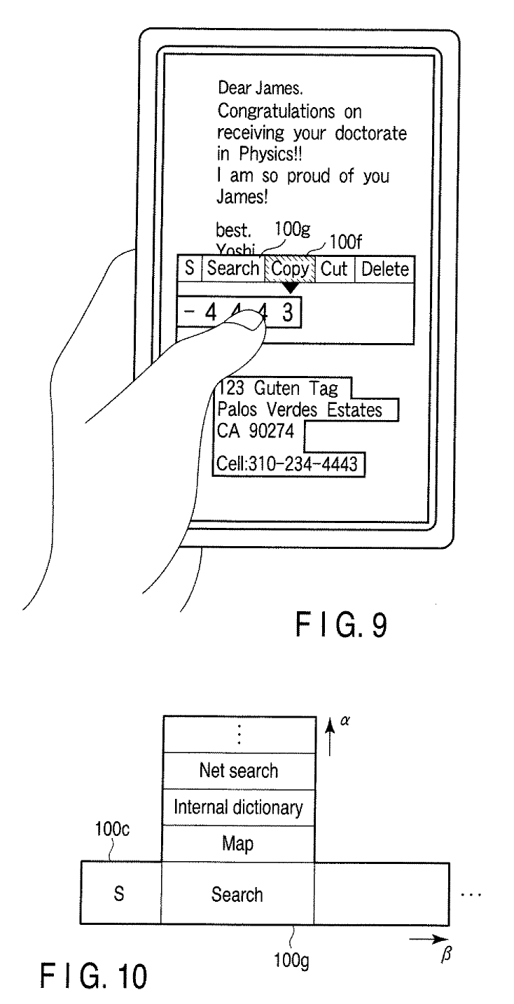

Upon detecting press on an item (YES in block S106: see FIG. 9), the display control application 100 executes the detected item (block S107). Upon detecting press on, e.g., “Copy” (100f in FIG. 9), the selected text data area is temporarily copied to the memory 16.

Upon detecting press on, e.g., “Search” (100g in FIG. 9), a menu is displayed in, e.g., the a direction from “Search”, as shown in FIG. 10, so that the user can select an item of a search target. For example, a search using the text data selected in block S105 can be done by selecting “map”, “internal dictionary”, or “net search”. For example, if the text data is a place name, it can be searched for in, e.g., an internal map application by selecting “map”. If the menu display area 100a of the display control application 100 cannot completely be displayed, the user can scroll the display in the β direction, as shown in FIG. 10 (an execution instruction can be displayed by scrolling in the menu).

In the above-described embodiment, long press of the user's finger 12 or the like on the display 15 is detected. However, the present invention is not limited to this. For example, the user's finger 12 moves to draw, e.g., a circle on the display 15 on which the X-axis is defined in the horizontal direction, and the Y-axis in the vertical direction. In this case, a character closest to the minimum value of (X,Y) may be selected. That is, the user need only be able to select text data using the touch panel.

It is an object of the present invention to provide an information processing apparatus capable of easily handling text data displayed on a display, a control method, and a storage medium.

According to the above-described embodiment, text data displayed on the display can easily be handled. More specifically, it is possible to comfortably edit (e.g., copy, delete, paste, cut, or search), with one hand, text data that is displayed in a small display area of the display of the PDA.

Note that the present invention is not exactly limited to the above embodiments, and constituent elements can be modified in the execution stage without departing from the spirit and scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a display unit which has a touch sensor on a screen;
a detection unit which causes the touch sensor to detect that press on an arbitrary text of text data displayed on the display unit has continued for a predetermined time;
a display control unit which displays a predetermined menu when the detection unit detects that the press has continued for the predetermined time;
a selection unit which, when a selection start instruction to select part of the text data is selected from the displayed menu, and an instruction to scroll display of the text data is input, selects the text data to expand a selection range in a scroll direction; and
a processing unit which, when the selection unit selects the text data, and an execution instruction of a predetermined function is selected from the menu, processes the execution instruction for the selected text data.

2. The apparatus of claim 1, wherein the text data is scrolled in the scroll direction before the selection start instruction is input.

3. The apparatus of claim 1, further comprising a display area where part of the text that is being scrolled in the text data is enlarged and displayed.

4. The apparatus of claim 1, wherein the execution instruction is displayable by scrolling in the menu.

5. The apparatus of claim 1, wherein the execution instruction includes one of copy, paste, delete, search, and cut.

6. A control method used in an information processing apparatus including a display unit which has a touch sensor on a screen, comprising:
displaying a predetermined menu when the touch sensor detects that press on an arbitrary text of text data displayed on the display unit has continued for a predetermined time;
when a selection start instruction to select part of the text data is selected from the displayed menu, and an instruction to scroll display of the text data is input, selecting the text data to expand a selection range in a scroll direction; and
when the text data is selected, and an execution instruction of a predetermined function is selected from the menu, processing the execution instruction for the selected text data.

7. The method of claim 6, wherein the text data is scrolled in the scroll direction before the selection start instruction is input.

8. The method of claim 6, further comprising a display area where part of the text data that is being scrolled is enlarged and displayed.

9. The method of claim 6, wherein the execution instruction is displayable by scrolling in the menu.

10. The method of claim 6, wherein the execution instruction includes one of copy, paste, delete, search, and cut.

11. A digital storage medium which stores a program to be used in an information processing apparatus including a display unit which has a touch sensor on a screen, the program causing a computer to execute:
a detection procedure of causing the touch sensor to detect that press on an arbitrary text of text data displayed on the display unit has continued for a predetermined time;
a display procedure of displaying a predetermined menu when it is detected in the detection procedure that the press has continued for the predetermined time;
a selection procedure of, when a selection start instruction to select part of the text data is selected from the menu displayed in the display procedure, and an instruction to scroll display of the text data is input, selecting the text data to expand a selection range in a scroll direction; and
an execution procedure of, when the text data is selected in the selection procedure, and an execution instruction of a predetermined function is selected from the menu, processing the execution instruction for the selected text data.
